(19) United States
(12) Patent Application Publication
(10) Pub. No.: US 2005/0243583 A1
(43) Pub. Date: Nov. 3, 2005

(54) Method and circuit for sensing the output current of power sources

(75) Inventor: Isaac Cohen, Dix Hills, NY (US)

Correspondence Address: ISAAC COHEN, 1171 CARLL'S STRAIGHT PATH, DIX HILLS, NY, 11746, US

(73) Assignee: LAMBDA ELECTRONICS, San Diego, CA (US)

(21) Appl. No.: 10/709,405

(22) Filed: May 3, 2004

(51) Int. Cl. H02J 1/02

(52) U.S. Cl. 363/65

(57) ABSTRACT

Disclosed is a method for sensing the output current of a power source by averaging and summing instantaneous current signals generated by current sense devices installed in converters fed by the said power source.

### BACKGROUND OF INVENTION

In some applications, one or more front-end converters are used to generate a regulated voltage that is used as a power source for one or more downstream converters. A sudden change in the output current of the front-end converters will cause the regulated voltage to sag.

The voltage sag can be reduced by sensing the output current of the front-end converters and providing this information to the control circuit of the front-end converter.

### PRIOR ART (REF. FIG. 1)

In the prior art, the front-end converter 2 processes power from the input voltage source 1 and creates an intermediate voltage on distribution bus 2.

This voltage feeds the downstream converters 5, 6 and 7.

The output current of the front-end converter 2 is sensed by shunt 8. The signal on shunt 8 can be used as an input for the control circuit 3 or for other control or monitoring purposes.

Although measuring current by means of a shunt is very simple, it has the disadvantage of poor signal-to-noise ratio, excessive power dissipation and sometimes significant cost.

### SUMMARY OF INVENTION

The present invention relies on current sensing devices that are typically present in the downstream converters to generate a signal that is an accurate representation of the output current of the front end converter or converters.

### BRIEF DESCRIPTION OF DRAWINGS

FIG. 1 shows the prior art

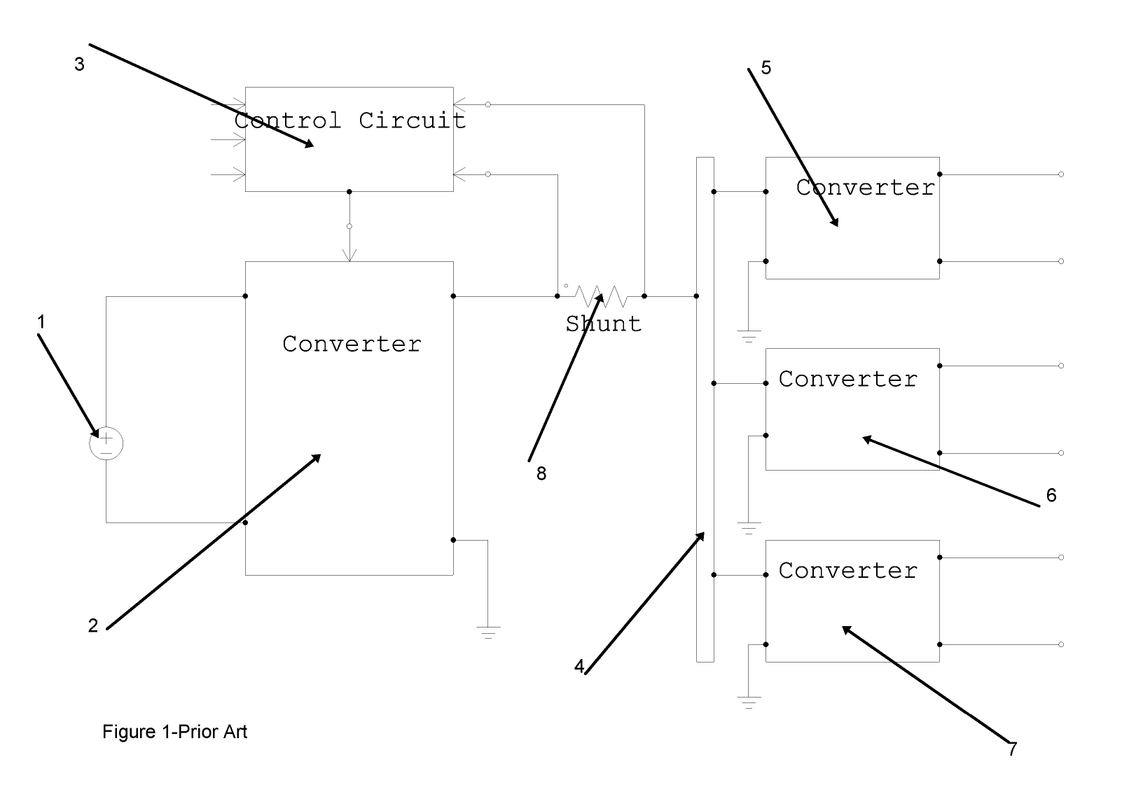

FIG. 2 shows the preferred embodiment of the present invention

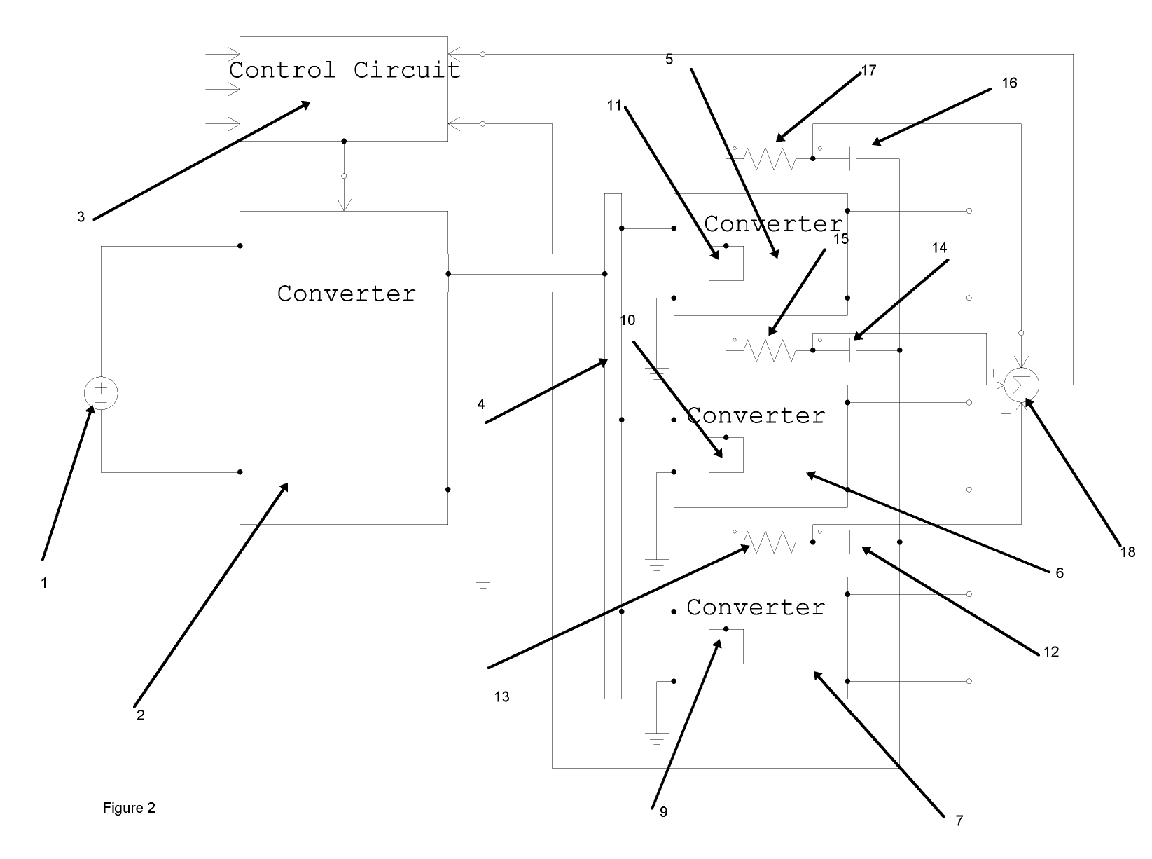

### DETAILED DESCRIPTION (REF. FIG. 2)

It is the goal of the present invention to eliminate the use of the shunt and to provide a current signal having a high signal-to-noise ratio.

For many converter topologies, the average input current of the converter is equal to the average current in the switches or transformers of the converter.

Virtually all converters contain current sensing means (represented by blocks 9, 10 and 11) that produce a signal proportional to the instantaneous current flowing in their switches or transformer/inductor windings.

The present invention takes advantage of these facts to allow measurement of the output current provided by the front-end source utilizing elements that are already present in the downstream converters.

As the output current of the front-end converter is equal to the sum of the average input currents of the downstream converters, by averaging and summing these signals, a signal can be generated that this proportional to the output current of the front-end converter.

In the preferred embodiment, the signals produced by the current sensing means 9, 10 and 11 located inside the downstream converters 5, 6 and 7 are averaged by the R/C networks 13/12, 15/14, and 17/16 and summed by the adding means 18.

The resulting signal is proportional to the output current of the front-end converter 2 and can be used for various control and/or monitoring purposes.

1. A method and circuit for generating a signal proportional to the output current of at least one electrical power source that feeds one or more other downstream converters, comprising:
current sensing means for generating signals proportional to the instantaneous current in the switches or transformers or inductors windings of the said downstream converters;
averaging and summing means to process the said signals and generate a signal that is proportional to the sum of the input currents of the said downstream converters and also to the output current of the said power source.

2. A method and circuit as of claim 1, where the power source for the downstream converters is at least one front end converter.

3. A method and circuit as of claim 1, where the averaging and summing means is analog.

4. The method and circuit as of claim 1 where the averaging and summing means is digital.

5. A method and circuit as of claim 1, where the said signal is used for control purposes.

6. A method and circuit as of claim 1, where the said signal is used for monitoring purposes.
